(19) United States
(12) Patent Application Publication
(10) Pub. No.: US 2026/0362477 A1
(43) Pub. Date: Nov. 12, 2026

(54) METHODS, ARCHITECTURES, APPARATUSES AND SYSTEMS FOR SCHEDULED AMBIENT INTERNET OF THINGS DEVICE RESPONSE MANAGEMENT

(71) Applicant: InterDigital Patent Holdings, Inc., Wilmington, DE (US)

(72) Inventors: Mohamad Kenan Al-Hares, Canterbury (GB); Michael Starsinic, Newtown, PA (US); Guanzhou Wang, Brossard (CA); Anuj Sethi, Ottawa (CA); Alec Brusilovsky, Downingtown, PA (US)

(21) Appl. No.: 19/202,781

(22) Filed: May 8, 2025

(51) Int. Cl. H04W 74/04; G16Y 20/20

(52) U.S. Cl. CPC H04W 74/04; G16Y 20/20

(57) ABSTRACT

Procedures, methods, architectures, apparatuses, systems, devices, and computer program products are provided for scheduled ambient internet of things (A-IoT) device response management. Wireless transmit/receive unit (WTRU) methods and systems include receiving, from a wireless network, a command request indicating scheduling information for an A-IoT device response. The methods and systems further include transmitting the command request to an A-IoT device and determining, based on the scheduling information, that the A-IoT device response has not been received from the A-IoT device at a scheduled time. The methods and systems additionally include, based on determining that the A-IoT device response has not been received from the A-IoT device at the scheduled time, initiating an inventory procedure with the A-IoT device.

### TECHNICAL FIELD

The present disclosure is generally directed to the fields of communications, software, and encoding/decoding, including, for example, to methods, architectures, apparatuses, systems related to communication with ambient internet of things (A-IoT) devices.

### BACKGROUND

An A-IoT device that is communicatively coupled to a wireless network may be configured to respond to requests from the wireless network. In some examples, the wireless network may desire one or more A-IoT device responses to occur at or by a scheduled time.

### SUMMARY

A wireless transmit/receive unit (WTRU) may be configured for A-IoT device communication. For example, a WTRU may be instructed by an application function (AF) to request information from an A-IoT device. However, the AF may indicate that the A-IoT device response (e.g., including the requested information) should be received at a scheduled time. For example, the A-IoT device may be associated with an AF request for a weather application requiring an A-IoT device reading every 100 ms. In such examples, it may be desired for the WTRU to perform an inventory procedure with the A-IoT device to check for A-IoT device availability or request the missing response. Accordingly, systems and methods are desired for management of scheduled A-IoT device responses. In accordance with certain embodiments of this disclosure, the WTRU receives a command request indicating scheduling information for an A-IoT device response and transmits the command request to the A-IoT device. The WTRU may determine, based on the scheduling information, that the A-IoT device response has not been received at a scheduled time and initiate an inventory procedure with the A-IoT device. Based on the systems and methods of this disclosure, the inventory procedure may be directly triggered by the WTRU upon detection of the missing response rather than relying on the AF to initiate the procedure, thus reducing the signaling required for management of scheduled A-IoT responses.

In accordance with certain embodiments of the present disclosure, methods and systems are provided for operating a WTRU. A method includes receiving, from a wireless network, a command request for an A-IoT device, the command request indicating scheduling information for one or more A-IoT device response. The method further includes transmitting, to the A-IoT device, the command request. The method additionally includes determining, based on the scheduling information, that an A-IoT device response of the one or more A-IoT device responses has not been received at a scheduled time. The method also includes, based on determining that the A-IoT device response has not been received at the scheduled time, initiating an inventory procedure by generating an inventory request for the A-IoT device.

In some embodiments, timing information is included in the scheduling information for the one or more A-IoT device responses. In some embodiments, the timing information can be generated by the WTRU. For example, the scheduling information may include one or more rules and the WTRU may generate the timing information based on the one or more rules. Further, for example, the one or more rules may include at least one of: a time of day, a location, a channel condition, an A-IoT device availability pattern, combinations of the same, or the like. Moreover, for example, the timing information may indicate a scheduled time for an A-IoT device response. In some embodiments, the WTRU determines that the A-IoT device response has not been received at the scheduled time based on the timing information. In some embodiments, the command request indicates a timer. In some embodiments, the WTRU determines that the A-IoT device response has not been received at the scheduled time based on the timer.

In some embodiments, the command request indicates an action to be performed by the WTRU upon determining that the A-IoT device response has not been received at the scheduled time. In some embodiments, based on determining that the A-IoT device response has not been received at the scheduled time, the WTRU performs the action indicated by the command request and transmits, to the wireless network an indication of the performed action. In some embodiments, the WTRU transmits, as part of the inventory procedure, the generated inventory request to the A-IoT device. In some embodiments, the WTRU receives, as part of the inventory procedure, an inventory response from the A-IoT device and transmits the inventory response to the wireless network. In some embodiments, the WTRU determines that the A-IoT device is unavailable based on failing to identify an inventory response from the A-IoT device and, based on the determination, transmits an indication that the A-IoT device is unavailable to the wireless network. In some embodiments, the WTRU determines that the A-IoT device response has not been received at the scheduled time further based on the timer indicated by the command request.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a system diagram depicting an example topology for A-IoT signaling involving bidirectional communication between an A-IoT device and an intermediate node, in accordance with certain embodiments;

FIG. 3 is a flowchart of an example A-IoT inventory procedure, in accordance with certain embodiments;

FIG. 4 is a flowchart of an example A-IoT device scheduled response management procedure, in accordance with certain embodiments; and

FIG. 5 is a flowchart of an illustrative method performed by a WTRU for managing A-IoT device scheduled responses, in accordance with certain embodiments.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, or the like and/or any element thereof carries out an operation, process, algorithm, function, or the like and/or any portion thereof, it is to be understood that any embodiments described and/or claimed herein assume that any apparatus, system, device, or the like and/or any element thereof is configured to carry out any operation, process, algorithm, function, or the like and/or any portion thereof.

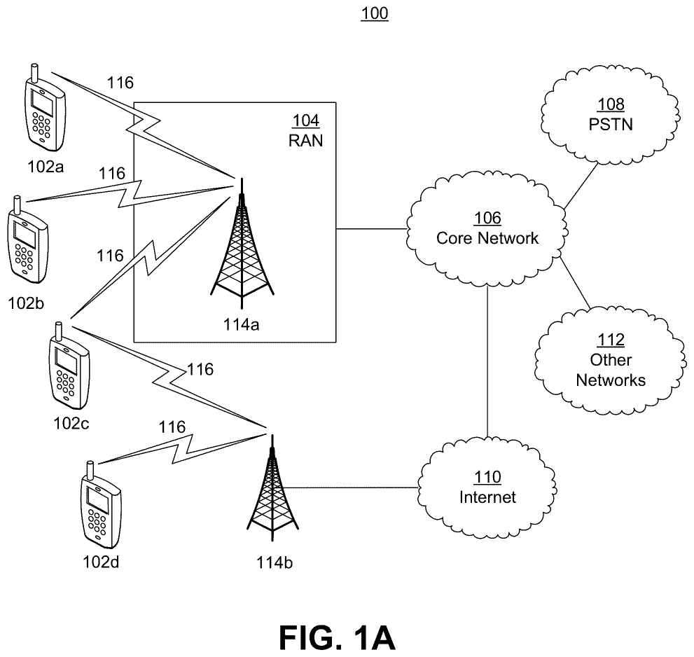

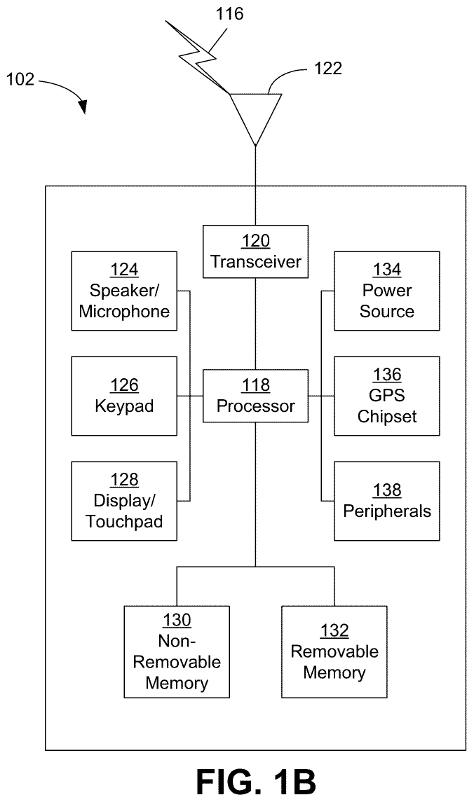

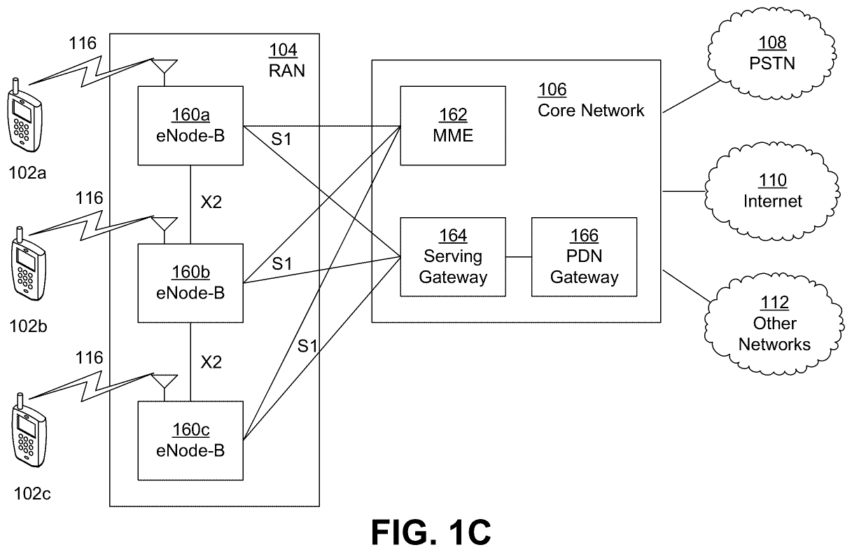

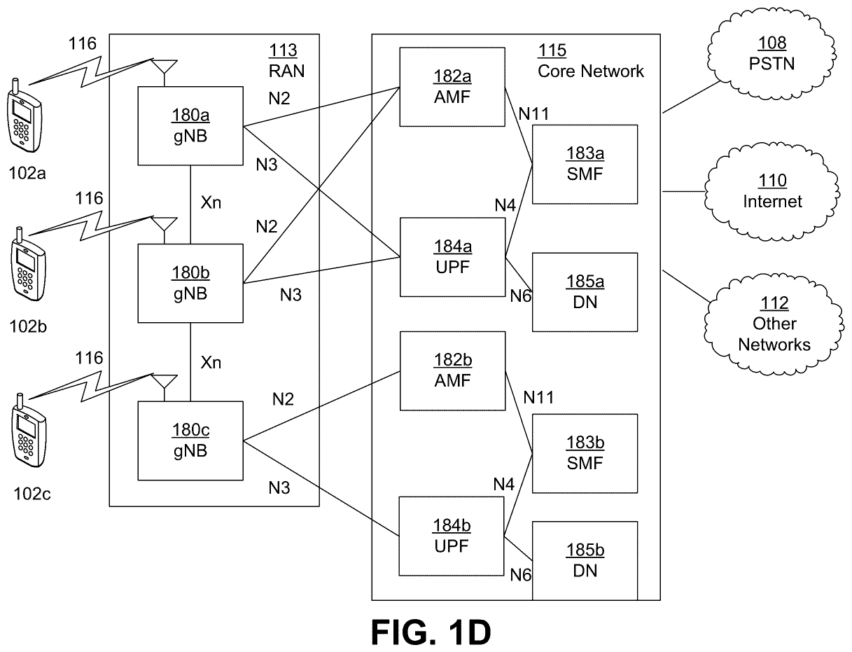

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, or the like, to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discrete Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNB, a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

It will be understood that a wireless network may include any suitable components and devices, including, for example, any of one or more base stations, one or more TRPs, one or more gNBs, one or more WTRUs, any network functions, one or more RANs, one or more application functions, one or more access and mobility management functions (AMFs), any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

The base station 114a may be part of the RAN 104/113, which may also include other base stations and/or network elements (not shown), such as a base station controller (BSC), a radio network controller (RNC), relay nodes, or the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, or the like). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, or the like) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, or the like, and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), or the like), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, or the like.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, orthogonal frequency division multiplexing (OFDM) symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards AMFs 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

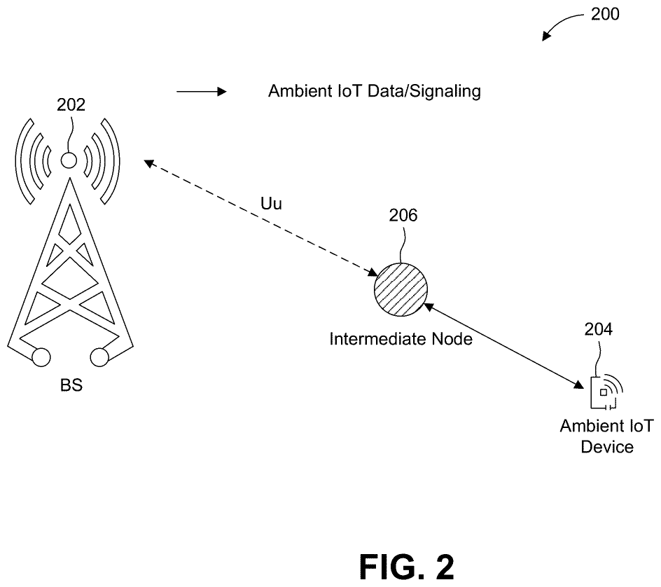

In certain embodiments of the present disclosure, including those described below at least in connection with FIGS. 2-5, the devices, systems, architectures, communication links, apparatuses, and other elements depicted in FIGS. 1A-1D may be used in connection with techniques for scheduled A-IoT device response management.

In accordance with certain embodiments of the present disclosure, an A-IoT signaling topology is described as follows.

FIG. 2 is a diagram depicting an example topology 200 for A-IoT signaling involving bidirectional communication between an A-IoT device 204 and an intermediate node 206, in accordance with certain embodiments.

As shown in FIG. 2, in some approaches, the A-IoT device 204 communicates bidirectionally with an intermediate node 206 between the A-IoT device 204 and a base station 202 (e.g., base stations 114a, 114b of FIG. 1A, eNode-Bs 160a-c of FIG. 1B, gNBs 180a-c of FIG. 1D) of a wireless network (e.g., RAN 104 and 113 of FIGS. 1A-D and/or core network 106 and 115 of FIGS. 1A-D). For example, the intermediate node 206 may include or correspond to at least one of: a WTRU (e.g., WTRU 102a-d of FIGS. 1A-1D); a relay; an integrated access and backhaul (IAB) node; a repeater; or the like. Further, for example, the intermediate node may be capable of A-IoT signaling and may transfer A-IoT information between the base station 202 and the A-IoT device 204.

In accordance with certain embodiments of the present disclosure, an A-IoT inventory procedure is described as follows.

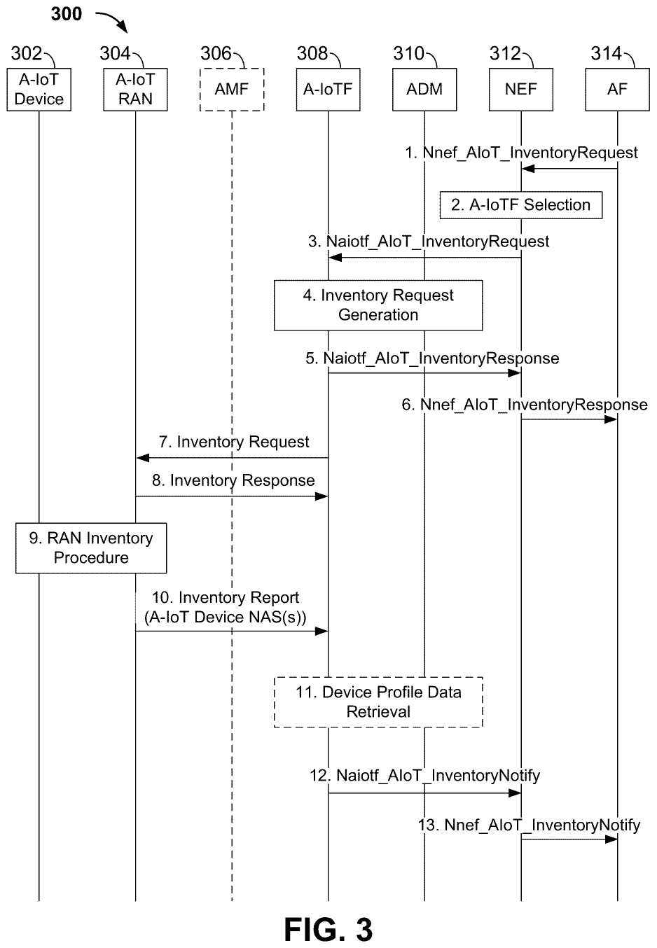

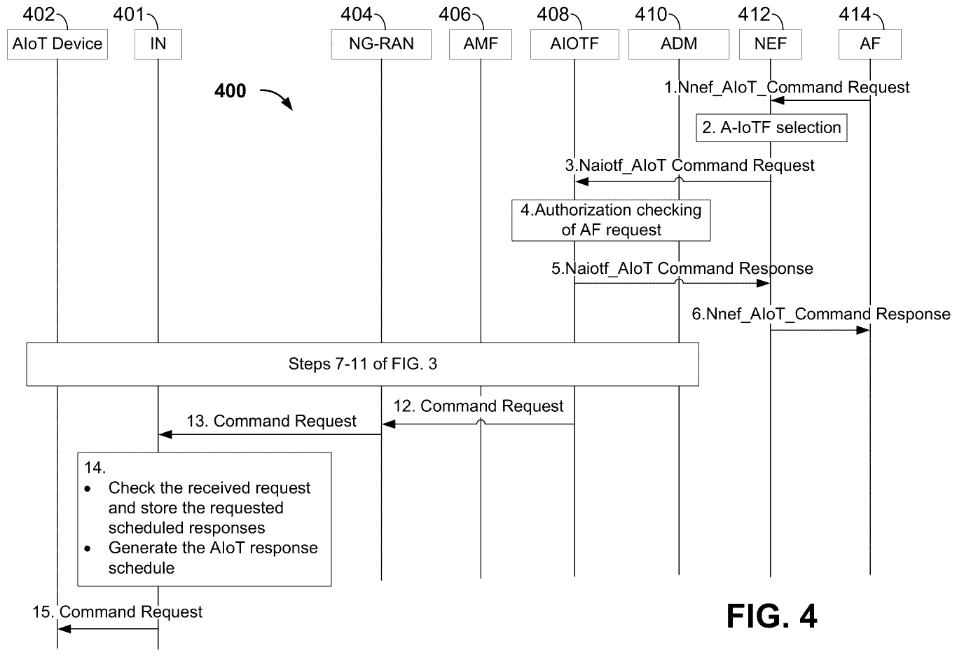

FIG. 3 is a flowchart of an example A-IoT inventory procedure 300, in accordance with certain embodiments.

As shown in FIG. 3, in some approaches, an application function (AF) 314 of a wireless network (e.g., core network 106 and 115 of FIGS. 1A-D) performs an inventory procedure 300 with an A-IoT device 302. For example, the wireless network may include at least one of: an A-IoT RAN 304 (e.g., RAN 104 and 113 of FIGS. 1A-D); an access and mobility management function (AMF) 306 (e.g., AMFs 182a-b of FIG. 1D); an A-IOT function 308 (A-IoTF); asset data management 310 (ADM); a network exposure function 312 (NEF); an AF 314; combinations of the same; or the like.

In some approaches, the wireless network (e.g., components of the wireless network) and/or the A-IoT device 302 performs at least one of the inventory procedure steps described as follows. At step 1, the AF 314 transmits an inventory request (e.g., an AF service operation request) to the NEF 312. At step 2, the NEF 312 selects one or more A-IoTFs 308 to generate the inventory request. At step 3, the NEF 312 transmits the inventory request to the selected A-IoTFs 308 and/or ADM 310. At step 4, the A-IoTF 308 and/or the ADM 310 generate an inventory request (e.g., for transmission to the A-IoT RAN 304). For example, generating the inventory request (e.g., for transmission to the A-IoT RAN 304) may include the A-IoTF 308 checking the parameters of the inventory request received from the AF 314. Further, for example, the A-IoTF 308 may generate a correlation ID corresponding to the AF service operation request based on successfully checking the parameters of the inventory request received from the AF 314. At step 5, based on successfully generating the inventory request (e.g., for transmission to the A-IoT RAN 304), the A-IoTF 308 transmits an inventory response to the NEF 312. At step 6, the NEF 312 transmits the received inventory response to the AF 314. At step 7, based on successfully generating the inventory request (e.g., for transmission to the A-IoT RAN 304), the A-IoTF 308 transmits the generated inventory request to the A-IoT RAN 304. At step 8, the A-IoT RAN 304 transmits a corresponding inventory response to the A-IoTF 308.

At step 9, the A-IoT device 302 and/or the A-IoT RAN 304 perform a RAN inventory procedure. For example, as a part of the RAN inventory procedure, the A-IoT RAN 304 transmits, to the A-IoT device 302, the inventory request received in step 7. Further, for example, as a part of the RAN inventory procedure, the A-IoT RAN 304 receives, from the A-IoT device 302, an inventory response. At step 10, the A-IoT RAN 304, transmits an inventory report to the A-IoTF 308 (e.g., based on the inventory response). For example, the inventory report may include one or more A-IoT device non-access stratums (NASs). At step 11, based on the received inventory report, the A_IoTF 308 and/or the ADM 310 may perform A-IoT device profile data retrieval to validate the inventory response. At step 12, based on validating the inventory response, the A-IoTF 308 and/or the ADM 310 notifies the NEF 312 of a valid inventory response. At step 13, based on receiving the notification of a valid inventory response in step 12, the NEF 312 forwards the notification of the valid inventory response to the AF 314.

In some approaches, an AF (e.g., AF 314 of FIG. 3) transmits a request requiring one or more scheduled response from an A-IoT device (e.g., A-IoT device 204 of FIG. 2, A-IoT device 302 of FIG. 3). For example, a scheduled response may include a response that is expected at a particular point in time in the future or multiple responses that are expected periodically. Further, for example, an AF request may be associated with a weather application requiring a reading (e.g., A-IoT device response) every 100 milliseconds. In such scenarios, A-IoT inventory procedures (e.g., A-IoT inventory procedure 300) and/or command procedures may not support the management of scheduled responses. Moreover, for example, additional checks for A-IoT device availability and/or reachability may be desired in scenarios where a reader (e.g., A-IoT RAN 304 of FIG. 3 or intermediate node 206 of FIG. 2) does not receive an expected response from the A-IoT device at a scheduled time. In some approaches, the reader may transmit, to the AF, a report of the response that was not received at the scheduled time and triggering of the inventory procedure may be limited to being performed by the AF. Such approaches may cause excessive signaling in the core network, between the RAN and the intermediate node, and/or between the intermediate node and the A-IoT device.

Accordingly, systems and methods are disclosed in the present disclosure for an A-IoT reader (e.g., RAN reader or intermediate node) to manage scheduled A-IoT device responses. In certain representative embodiments, a WTRU (e.g., WTRU 102a-d of FIGS. 1A-1D, intermediate node 206 of FIG. 2) may perform at least one of the following steps: receiving a command request from a RAN of a wireless network (e.g., next generation (NG) RAN); generating scheduling information for an A-IoT device; transmitting the command request to the A-IoT device; receiving a command response from the A-IoT device; determining that a scheduled A-IoT device response was not received; transmitting an inventory request to the A-IoT device; transmitting an update message to an AF of the wireless network; receiving an inventory response from the A-IoT device; transmitting the inventory response to the AF (e.g., via the NG-RAN); combinations of the same; or the like.

In certain representative embodiments, the command request includes at least one of the following: an A-IoT device ID; an indicator that the command request requires a sequence of A-IoT responses; an A-IoT device response schedule; a response timer; schedule generation rules; a command request ID; combinations of the same; or the like. In some embodiments, the WTRU generates an A-IoT device response schedule based on the schedule generation rules.

In certain representative embodiments, the command response indicates that the response schedule has been received at the A-IoT device.

In certain representative embodiments, the WTRU determines that one of the A-IoT device responses was not received at the scheduled time based on the (e.g., generated) response schedule and expiration of a timer (e.g., indicated by the command request). In some embodiments, the timer is configured based on the response schedule. In some embodiments, based on determining that an A-IoT response was not received at the scheduled time, the WTRU triggers the transmission of the inventory request to the A-IoT device. In some embodiments, the transmission of the inventory request is a part of an inventory procedure for checking A-IoT device availability and triggers the A-IoT device to send the A-IoT response that was not received at the scheduled time.

In certain representative embodiments, the inventory request includes an A-IoT device ID and/or missed scheduled response information (e.g., scheduled time, A-IoT device response information type, command request ID and/or inventory request ID, or the like). In certain representative embodiments, the update message includes at least one of the missed scheduled response and/or the missed scheduled response information (e.g., scheduled time, A-IoT device response information type, command request ID and/or inventory request ID, or the like). In certain representative embodiments, the inventory response includes at least one of the missed scheduled response and/or the missed scheduled response information (e.g., scheduled time, A-IoT device response information type, command request ID and/or inventory request ID, or the like).

In accordance with certain embodiments of the present disclosure, intermediate node management of scheduled A-IoT responses is described as follows.

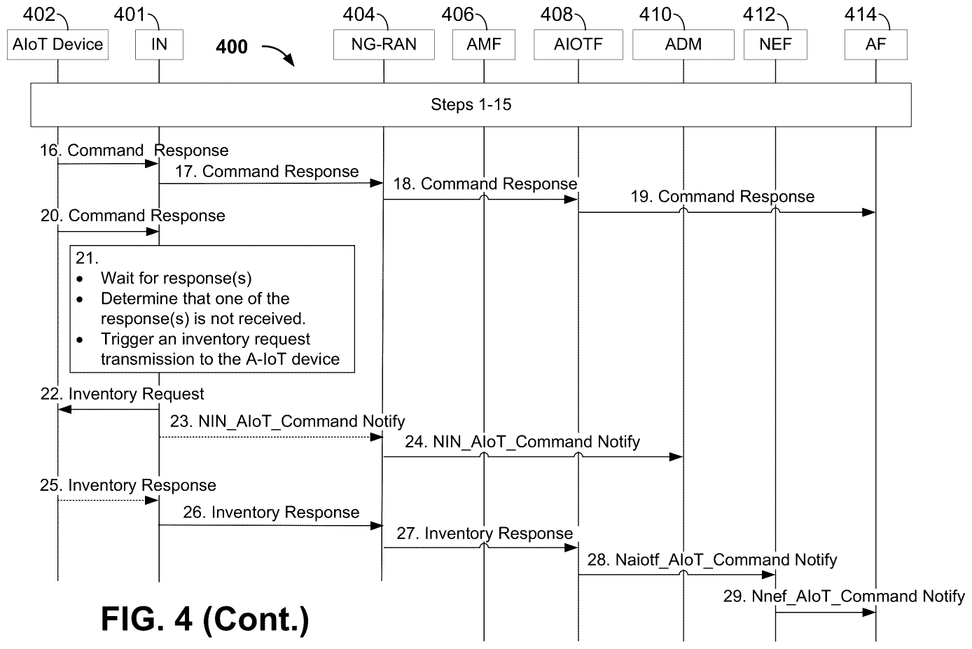

FIG. 4 is a flowchart of an example A-IoT device scheduled response management procedure 400, in accordance with certain embodiments.

As shown in FIG. 4, an intermediate node 401 (e.g., WTRU 102a-d of FIGS. 1A-1D, intermediate node 206 of FIG. 2) in connection with a wireless network (e.g., core network 106 and 115 of FIGS. 1A-D) may manage scheduled responses of an A-IoT device 402. For example, the wireless network may include at least one of: an A-IoT RAN 304 (e.g., RAN 104 and 113 of FIGS. 1A-D, A-IoT RAN 304 of FIG. 3); an AMF 406 (e.g., AMFs 182a-b of FIG. 1D, AMF 304 of FIG. 3); an A-IOTF 408 (e.g., A-IoTF 308 of FIG. 3); ADM 410 (e.g., ADM 310 of FIG. 3); a NEF 412 (e.g., NEF 312 of FIG. 3); an AF 414 (e.g., AF 314 of FIG. 3); combinations of the same; or the like.

In certain representative embodiments, the A-IoT device scheduled response management procedure 400 includes at least one of the steps described as follows.

At step 1, the AF 414 transmits a command request (e.g., Nnef_AIoT_Command request) to the NEF 412. For example, the command request may include one or more A-IoT device IDs and a requested information type. Further, for example, the command request might include an indication of a required sequence of A-IoT responses. Moreover, for example, the command request may indicate that the A-IoT device 402 should transmit responses (e.g., indicating the requested information) at particular times or time intervals. Also, for example, the command request may indicate that any information detected or recorded by the A-IoT device during a particular certain period needs to be sent to the core network (e.g., A-IoTF 408 and/or AF 414). Additionally, the command request may indicate a request ID (e.g., command request ID).

In some embodiments, the command request includes one or more rules, which the intermediate node 401 uses to generate a response schedule. For example, the rules may indicate at least one of: a time of the day, a location, a channel condition, an A-IoT device availability pattern, combinations of the same, or the like. Further, for example, a time of the day rule may indicate that ten responses should be sent by the A-IoT device 402 every minute during the day and fifteen responses should be send by the A-IoT device 402 every minute at night. In some embodiments, the command request includes a response timer as well. For example, the response timer is used by the intermediate node 401 to determine whether a response has been received at a scheduled time from the A-IoT device 402.

At step 2, the NEF 412 selects an A-IoTF 408 (e.g., or multiple A-IoTFs) for AF request authorization. In some embodiments, no A-IoTF is available to be selected, and the NEF 412 rejects the A-IoT command request with an appropriate cause code. For example, the NEF 412 transmits an indication of the rejection and the cause code to the AF 414.

At step 3, the NEF 412 sends the command request (e.g., Naiotf_AIoT_Command request) to the selected A-IoTF 408.

At step 4, the A-IoTF 408 receives the command request and checks the parameters included in the request. In some embodiments, the A-IoTF 408 performs AF authorization for the command request and performs AMF 406 selection. In some embodiments, the A-IoTF 408 performs NG-RAN 404 selection and/or RAN Reader selection.

At step 5, the A-IoTF 408 transmits the command response (e.g., Naiotf_AIoT_Command response) to the NEF 412.

At step 6, the NEF 412 transmits the command response (e.g., Nnef_AIoT_Command response) to the AF 414. In some embodiments, if the command response includes a rejection indication, then the procedure is terminated. In some embodiments, if the procedure is accepted, the command response includes an indication that the A-IoT procedure may be resumed (e.g., and a command request ID).

In some embodiments, following steps 1-6 of FIG. 4, the A-IoT device 402, intermediate node 401, NG-RAN 404, AMF 406, A-IoTF 408, and/or ADM 410 perform the steps 7-11 of FIG. 3. In some embodiments, as a part of steps 7-11 of FIG. 3, the A-IoTF 408 generates an inventory request. In some embodiments, the inventory request generation includes the A-IoTF checking the AF request parameters, and generating, if the request parameters check is successful, a correlation ID corresponding to the AF request. For example, the inventory request may indicate that the command request that triggered the inventory procedure, and/or a command request that will follow the inventory procedure. In some embodiments, when the inventory request is generated, the A-IoTF 408 transmits the generated inventory request through the A-IoT RAN (e.g., A-IoT RAN 304 of FIG. 3) to the A-IoT device 402. In some embodiments, when the A-IoT device 402 responds, the A-IoTF 408 validates the A-IoT device response using A-IoT device profile information provided by the ADM 410 and forwards the A-IoT device response to the AF 414 through the NEF 412.

At step 12, the A-IoTF transmits the command request to the NG-RAN 404. For example, the command request may include: an NG-RAN ID, an A-IoT device ID, an indicator that the command request requires a sequence of A-IoT device responses; a response schedule; combinations of the same; or the like. Further, for example, the response schedule may indicate exact times, frequencies and/or time intervals the A-IoT device 402 should transmit certain information to the intermediate node 401.

In some embodiments, the command request includes schedule generation rules which the intermediate node 401 uses to generate a response schedule. For example, such schedule generation rules may indicate at least one of: a time of the day, a location, a channel condition, an A-IoT device availability pattern, or the like. Further, for example, a schedule generation rule may indicate that ten responses should be sent by the A-IoT device 402 every minute during the day and fifteen responses should be sent by the A-IoT device 402 every minute at night. Moreover, for example, the command request may include a response timer. Also, for example, the command request may include an action (e.g., or sequence of actions) for the intermediate node 401 to perform if an A-IoT device response is not received at a scheduled time. Additionally, for example, the A-IoTF 408 may indicate to the intermediate node 401 to send an inventory request without contacting the core network. In one example, the intermediate node 401 receiving such an indication, upon determining that an A-IoT device response was not received at a scheduled time, transmits an inventory request to the A-IoT device 402 without contacting the AF 414 regarding the missed response and waiting the AF to transmit inventory. In some embodiments, the A-IoTF 408 instructs the intermediate node 401 to check with the AIoTF 408 before transmitting any inventory requests to the A-IoT device 402.

At step 13, the NG-RAN 404 forwards the command request (e.g., a NAS command request) to the intermediate node. For example, the command request may indicate at least one of: an A-IoT device ID, an indicator that this request requires a sequence of A-IoT device responses; a response schedule; combinations of the same; or the like. Further, for example, the response schedule might indicate exact times, frequencies or time intervals the AIoT device 402 should send certain information to the intermediate node 401. Moreover, for example, the command request may indicate one or more schedule generation rules for the intermediate node 401 to generate the response schedule. Additionally, for example, the command request may include the response timer and request ID.

At step 14, the intermediate node 401 receives the command request from the A-IoTF 408 through NG-RAN 404. For example, the intermediate node 401 may check the received request from the AF 4141 and store the response schedule as requested by the AF 414. Further, for example, the intermediate node may identify any missing responses (e.g., responses not received at a scheduled time) from the A-IoT device and a request ID. Also, for example, the intermediate node 401 may generate the response schedule based on the received schedule generation rules from the AF 414. In some embodiments, if the intermediate node 401 is associated with an artificial intelligence (AI) agent, the intermediate node 401 may generate the schedule based on the schedule generation rules as well as additional information including at the least one of: a time of day; a location; a channel condition; an A-IoT device availability patter; combinations of the same; or the like.

At step 15, the intermediate node 401 transmits the command request to the A-IoT device 402. In some embodiments, the command request includes at least one of: a requested information type, a schedule to send responses to the AF 414, a request ID, or the like.

At step 16, the A-IoT 408 device responds to the command request. For example, the message may include an acknowledgment that the response schedule has been received and that the requested information from the A-IoT device has been determined as well.

At step 17, the intermediate node 201 transmits the command response to the NG-RAN 404.

At step 18, the NG-RAN 404 transmits the command response to the A-IoTF 408.

At step 19, the A-IoTF 408 transmits the command response to the AF 414.

At step 20, the A-IoT 402 may transmit a scheduled A-IoT device response to the intermediate node 401. For example, the scheduled response may include the requested information in step 15 and request ID. Similar to steps 17, 18, and 19, the scheduled A-IoT device response may be sent to the AF 414. In some embodiments, step 20 may be repeated multiple times during a time period according to the received schedule.

At step 21, the intermediate node 401 determines that a scheduled A-IoT device response has not been received from the A-IoT device 402. For example, the determination may be based on a timer indicated previously in the command request from the AF 414. Further, for example, the intermediate node 401 may be triggered to send an inventory request to the A-IoT device 402 to check the device availability and/pr missed response. Also, for example, the A-IoTF 408 may communicate in the command request to the A-IoT device the action that needs to be taken by the intermediate node in a scenario where no response is received. Moreover, for example, the A-IoTF 408 may permit the intermediate node 401 to transmit an inventory request immediately if no A-IoT device response is received at the expected time. In some embodiments, the A-IoTF instructs the intermediate node 401 to check with the A-IoTF 408 before sending any inventory request.

At step 22, the intermediate node 401 transmits an inventory request to the A-IoT device 402. For example, the inventory request may indicate an A-IoT device ID and/or missed response details (e.g., scheduled time, information type, or the like). Further, for example, the inventory request may include an initial request ID (e.g., command request ID) sent to the A-IoT device in step 18.

At step 23, the intermediate node 401 transmits an updated message to the NG-RAN 404 regarding the missed response and the action taken. For example, the updated message might include a request ID, a missed response time and/or an A-IoT device ID.

At step 24, the NG-RAN 404 forwards the updated message (e.g., of step 23) to the A-IoTF 408 and/or ADM 410.

At step 25, if available, the A-IoT device 402 may transmit an inventory response message to the intermediate node 401. For example, the inventory response message may include at least one of: the missed response, missed response details (e.g., scheduled time, information type, or the like), and a request ID. Further for example, the inventory response message may indicate that the requested information is not available.

In some embodiments, the A-IoT device 402 does not reply to the inventory request and the intermediate node 401 may determine that the A-IoT device 402 is not available. In such scenarios, the intermediate node may inform the A-IoTF 408 that the AIoT device is not available and may indicate to the A-IoTF 408 that one or more future scheduled responses may not be received.

At step 26, the intermediate node 401 transmits the inventory response to the NG-RAN 404. For example, the inventory response includes at least one of: the missed A-IoT device response, missed A-IoT device response information, a request ID (e.g., a command request ID, an inventory request ID), combinations of the same, or the like.

At step 27, the NG-RAN 404 transmits the inventory response to the A-IoTF 408.

At step 28, the A-IoTF 408 reports the result of the A-IoT command request to the NEF 412 by sending a notification (e.g., a Naiotf_AIoT_Command notify message). For example, the notification may indicate at least one of: A-IoT device IDs, AF IDs, A-IoT data, combinations of the same, or the like.

At step 29, the NEF 412 forwards the received report (e.g., notification) from the A-IoTF 408 to the AF 414.

In accordance with certain embodiments of the present disclosure, NG-RAN management of scheduled A-IoT device responses are described as follows.

In certain representative embodiments, an NG-RAN (e.g., NG-RAN 404 of FIG. 4) may directly communicate with the A-IoT device (e.g., A-IoT device 402 of FIG. 4). In such embodiments, the NG-RAN may perform any of the aforementioned steps described in association with the intermediate node (e.g., intermediate node 401 of FIG. 4).

In certain representative embodiments, the NG-RAN may be the A-IoT reader and perform at least one of steps described as follows.

In some embodiments (e.g., at steps 12-14 of FIG. 4), the NG-RAN receives the command request from the A-IoTF and stores and/or generates the A-IoT device response schedule.

In some embodiments (e.g., at steps 15 and 21 of FIG. 4), the NG-RAN determines that an A-IoT device response has not been received at the scheduled time. For example, the NG-RAN may make this determination based on a timer communicated in the command request from the AF. Further, for example, based on determining that the A-IoT device response has not been received at the scheduled time, the NG-RAN may transmit an inventory request to the A-IoT device to check for A-IoT device availability and/or trigger the A-IoT device to retransmit missed responses. Moreover, for example, the A-IoTF may include in the inventory request an action to be performed by the NG-RAN upon determining that an A-IoT device response has not been received at the scheduled time. Also, for example, the A-IoTF may indicate to the NG-RAN to immediately transmit an inventory request to the A-IoT device upon determining that the A-IoT device response has not been received at the scheduled time.

In some embodiments (e.g., at step 22 of FIG. 4), the NG-RAN transmits an inventory request to the A-IoT device. For example, the inventory request may include the A-IoT device ID, and/or missed A-IoT device response information (e.g., expected time and information type).

In some embodiments (e.g., at step 25 of FIG. 4), the NG-RAN receives an inventory response from the A-IoT device.

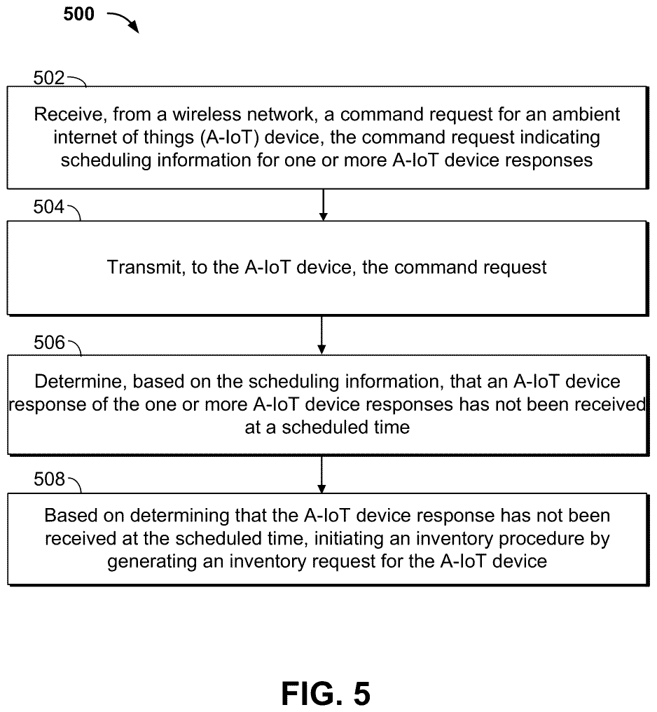

FIG. 5 is a flowchart of an illustrative method 500 performed by a WTRU for managing A-IoT device scheduled responses, in accordance with certain embodiments.

In certain representative embodiments, as shown in FIG. 5, a process 500 is performed by a WTRU (e.g., WTRU 102 of FIGS. 1A-1D, intermediate node 206 of FIG. 2, intermediate node 401 of FIG. 4) in connection with a wireless network (e.g., RAN 104 and 113 of FIGS. 1A-D and/or core network 106 and 115 of FIGS. 1A-1D, network entities 304-314 of FIG. 3, network entities 404-414 of FIG. 4), which may be implemented in communications system 100 illustrated in FIG. 1A-1D.

At step 502, the WTRU receives, from a wireless network, a command request for an A-IoT device. In some embodiments, the command request indicates scheduling information for one or more A-IoT device responses. In some embodiments, timing information is included in the scheduling information for the one or more A-IoT device responses. In some embodiments, the timing information can be generated by the WTRU. For example, the scheduling information may include one or more rules and the WTRU may generate the timing information based on the one or more rules. Further, for example, the one or more rules may include at least one of: a time of day, a location, a channel condition, an A-IoT device availability pattern, combinations of the same, or the like. Moreover, for example, the timing information may indicate a scheduled time for an A-IoT device response. In some embodiments, the command request indicates an action to be performed by the WTRU upon determining that the A-IoT device response has not been received at the scheduled time. In some embodiments, the command request indicates a timer.

At step 504, the WTRU transmits, to the A-IoT device, the command request. In some embodiments, the WTRU receives, from the A-IoT device a command response associated with the command request. For example, the command response may indicate acknowledgement of the scheduling information of the command request.

At step 506, the WTRU determines, based on the scheduling information, that an A-IoT device response of the one or more A-IoT device responses has not been received at a scheduled time. In some embodiments, the WTRU determines that the A-IoT device response has not been received at the scheduled time based on the timing information. In some embodiments, based on determining that the A-IoT device response has not been received at the scheduled time, the WTRU performs the actions indicated by the command request and transmits, to the wireless network an indication of the performed action.

At step 508, the WTRU, based on determining that the A-IoT device response has not been received at the scheduled time, initiating an inventory procedure by generating an inventory request for the A-IoT device. In some embodiments, the WTRU transmits, as part of the inventory procedure, the generated inventory request to the A-IoT device. For example, the generated inventory request indicates at least one of: an A-IoT device ID (e.g., of the A-IoT device to which the inventory request is transmitted), the scheduled time, an A-IoT device response information type, or a command request ID. In some embodiments, the WTRU receives, as part of the inventory procedure, an inventory response from the A-IoT device and transmits the inventory response to the wireless network. In some embodiments, the WTRU determines that the A-IoT device is unavailable based on failing to identify an inventory response from the A-IoT device and, based on the determination, transmits an indication that the A-IoT device is unavailable to the wireless network. In some embodiments, the WTRU determines that the A-IoT device response has not been received at the scheduled time further based on the timer indicated by the command request.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, or the like, and a transmission type medium such as a digital and/or an analog communication medium (e.g., a fiber optic cable, a waveguide, a wired communications link, a wireless communication link, or the like).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, or the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, or the like). In those instances where a convention analogous to “at least one of A, B, or C, or the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, or the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, or the like. As a non-limiting example, each range discussed herein may be readily broken down into a lower third, middle third and upper third, or the like. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6 or means-plus-function claim format, and any claim without the terms “means for” is not so intended.

What is claimed is:

1. A method performed by a wireless transmit/receive unit (WTRU), the method comprising:
receiving, from a wireless network, a command request for an ambient internet of things (A-IoT) device, the command request indicating scheduling information for one or more A-IoT device responses;
transmitting, to the A-IoT device, the command request;
determining, based on the scheduling information, that an A-IoT device response of the one or more A-IoT device responses has not been received at a scheduled time; and
based on determining that the A-IoT device response has not been received at the scheduled time, initiating an inventory procedure by generating an inventory request for the A-IoT device.

2. The method of claim 1, wherein the scheduling information comprises timing information for the one or more A-IoT device responses, the timing information indicating the scheduled time for the A-IoT device response.

3. The method of claim 1, wherein:
the scheduling information indicates one or more rules; and
determining that the A-IoT device response has not been received at the scheduled time comprises:
generating timing information based on the one or more rules, the timing information indicating the scheduled time for the A-IoT device response; and
determining, based on the timing information, that the A-IoT device response has not been received at the scheduled time.

4. The method of claim 3, wherein the one or more rules indicate at least one of:
a time of day;
a location;
a channel condition; or
an A-IoT device availability pattern.

5. The method of claim 1, wherein:
the command request indicates a timer; and
determining that the A-IoT device response of the one or more A-IoT device responses has not been received at the scheduled time is further based on the timer.

6. The method of claim 1, wherein the command request indicates an action to be performed by the WTRU upon determining that the A-IoT device response has not been received at the scheduled time.

7. The method of claim 6, the method further comprising:
based on determining that the A-IoT device response has not been received at the scheduled time, performing the action indicated by the command request; and
transmitting, to the wireless network, an indication of the performed action.

8. The method of claim 1, further comprising:
transmitting, as part of the inventory procedure, the generated inventory request to the A-IoT device, wherein the generated inventory request indicates at least one of:
a device ID associated with the A-IoT device;
the scheduled time;
an A-IoT device response information type; or
a request ID associated with the command request.

9. The method of claim 8, further comprising:
receiving, as part of the inventory procedure, an inventory response from the A-IoT device; and
transmitting the inventory response to the wireless network.

10. The method of claim 8, further comprising:
determining that the A-IoT device is unavailable based on failing to identify an inventory response from the A-IoT device; and
transmitting an indication that the A-IoT device is unavailable to the wireless network.

11. A wireless transmit/receive unit (WTRU), the WTRU comprising:
a processor; and
a transceiver coupled to the processor, wherein the WTRU is configured to:
receive, from a wireless network, a command request for an ambient internet of things (A-IoT) device, the command request indicating scheduling information for one or more A-IoT device responses;
transmit, to the A-IoT device, the command request;
determine, based on the scheduling information, that an A-IoT device response of the one or more A-IoT device responses has not been received at a scheduled time; and
based on determining that the A-IoT device response has not been received at the scheduled time, initiate an inventory procedure by generating an inventory request for the A-IoT device.

12. The WTRU of claim 11, wherein the scheduling information comprises timing information for the one or more A-IoT device responses, the timing information indicating the scheduled time for the A-IoT device response.

13. The WTRU of claim 11, wherein:
the scheduling information indicates one or more rules; and
the WTRU is configured to determine that the A-IoT device response has not been received at the scheduled time by:
generating timing information based on the one or more rules, the timing information indicating the scheduled time for the A-IoT device response; and
determining, based on the timing information, that the A-IoT device response has not been received at the scheduled time.

14. The WTRU of claim 13, wherein the one or more rules indicate at least one of:
a time of day;
a location;
a channel condition; or
an A-IoT device availability pattern.

15. The WTRU of claim 11, wherein:
the command request indicates a timer; and
the WTRU is configured to determine that the A-IoT device response of the one or more A-IoT device responses has not been received at the scheduled time further based on the timer.

16. The WTRU of claim 11, wherein the command request indicates an action to be performed by the WTRU upon determining that the A-IoT device response has not been received at the scheduled time.

17. The WTRU of claim 16, the WTRU further configured to:
based on determining that the A-IoT device response has not been received at the scheduled time, perform the action indicated by the command request; and
transmit, to the wireless network, an indication of the performed action.

18. The WTRU of claim 11, the WTRU further configured to:
transmit, as part of the inventory procedure, the generated inventory request to the A-IoT device, wherein the generated inventory request indicates at least one of:
a device ID associated with the A-IoT device;
the scheduled time;
an A-IoT device response information type; or
a request ID associated with the command request.

19. The WTRU of claim 18, the WTRU further configured to:
receive, as part of the inventory procedure, an inventory response from the A-IoT device; and
transmit the inventory response to the wireless network.

20. The WTRU of claim 18, the WTRU further configured to:
determine that the A-IoT device is unavailable based on failing to identify an inventory response from the A-IoT device; and
transmit an indication that the A-IoT device is unavailable to the wireless network.
